(19) United States
(12) Patent Application Publication
(10) Pub. No.: US 2016/0224648 A1
(43) Pub. Date: Aug. 4, 2016

(54) Method and system for performing a synchronization operation

(71) Applicant: Apollo Education Group, Inc., San Jose, CA (US)

(72) Inventor: David Le, San Jose, CA (US)

(21) Appl. No.: 14/610,790

(22) Filed: Jan. 30, 2015

(51) Int. Cl. G06F 17/30; H04L 12/801; H04L 12/26; H04W 52/02

(52) U.S. Cl. CPC G06F 17/30575; H04W 52/0258; H04L 47/127; H04L 43/0876; H04W 84/12

(57) ABSTRACT

At least one pattern associated with a device is identified. Based on the pattern, a time is selected to synchronize data stored on the device with data stored on another device. A synchronization operation is performed at the selected time.

### TECHNICAL FIELD

The present disclosure relates to data synchronization between devices. In particular, the present disclosure relates to selecting a time to perform synchronization operations.

### BACKGROUND

Data stored on a particular device is often received from one or more other devices or transmitted to one or more other devices for backup storage. The transmission of data to another device or receipt of data from another device for synchronizing copies of data across multiple devices is referred to herein as a synchronization operation. A synchronization operation may be performed to synchronize a complete data set or a portion of the data set across multiple devices.

Performing a synchronization operation uses device and/or network resources such as, but not limited to, battery power, CPU cycles, network bandwidth, and disk I/O bandwidth. The use of resources by a synchronization operation may result in less than optimal performance for other concurrently executing or later executing operations. For example, a synchronization operation performed by a particular device while the particular device is receiving a live video stream may result in a reduction in video quality due to limited network bandwidth which is shared by both the synchronization operation and live video streaming operation. In another example, a synchronization operation may use up a battery charge on a cellular phone, resulting in reduction of the amount of time that the phone is in an “on” state.

The approaches described in this section are approaches that could be pursued, but not necessarily approaches that have been previously conceived or pursued. Therefore, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for performing a synchronization operation in accordance with one or more embodiments;

FIG. 3 illustrates an example set of operations for performing a synchronization operation in accordance with one or more embodiments;

FIG. 4 illustrates a system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention. The detailed description includes the following sections:
1. GENERAL OVERVIEW
2. ARCHITECTURAL OVERVIEW
3. PERFORMING A SYNCHRONIZATION OPERATION
   3.1 IDENTIFYING AT LEAST ONE PATTERN
   3.2 SELECTING A TIME FOR A SYNCHRONIZATION OPERATION BASED ON THE AT LEAST ONE PATTERN
   3.3 PERFORMING A SYNCHRONIZATION OPERATION
   3.4 UPDATING A SELECTED TIME FOR SYNCHRONIZATION OPERATIONS
4. SYNCHRONIZATION OPERATIONS BASED ON CURRENT A BATTERY LEVEL
5. MISCELLANEOUS; EXTENSIONS
6. HARDWARE OVERVIEW

1. General Overview

One or more embodiments relate to selecting a time for performing one or more synchronization operations to synchronize data across two or more devices.

An embodiment includes detecting a pattern associated with a first device. The embodiment further includes selecting a time for performing a synchronization operation associated with the first device based on the detected pattern, and performing the synchronization operation at the selected time.

An embodiment includes detecting a current battery level associated with a first device. The embodiment further includes determining whether or not to perform a synchronization operation associated with the first device based on the current battery level.

2. Architectural Overview

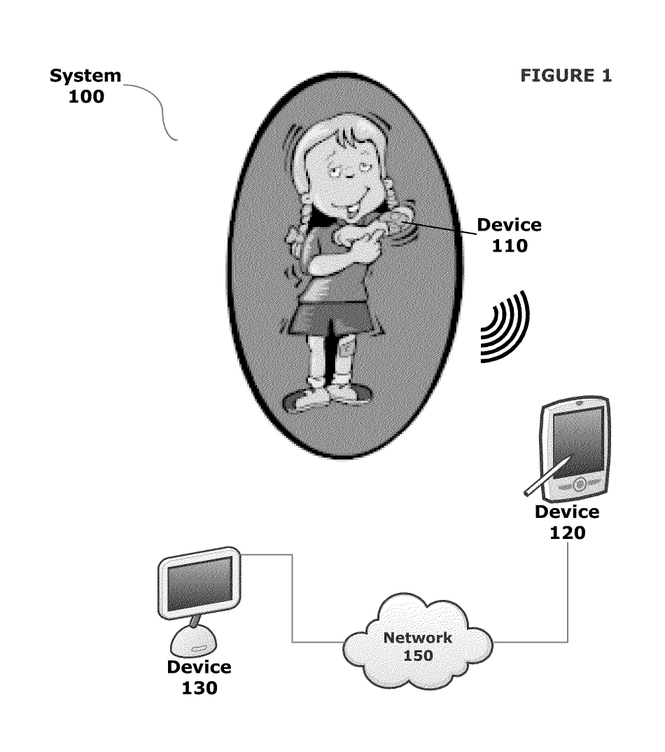

FIG. 1 illustrates a system (100) in accordance with one or more embodiments. Although a specific system is described, other embodiments are applicable to any system that can be used to perform the functionality described herein. Additional or alternate components may be included that perform functions described herein. Components described herein may be altogether omitted in one or more embodiments. One or more components described within system (100) may be combined together in a single device.

Components of the system (100) are connected by, without limitation, a network such as a Local Area Network (LAN), Wide Area Network (WAN), the Internet, Intranet, Extranet, and/or satellite links. Any number of devices connected within the system (100) may be directly connected to each other through wired and/or wireless communication segments (e.g., via Network (150)). In one example, devices within system (100) are connected via a direct wireless connection such a Bluetooth connection, a Near Field Communication (NFC) connection, and/or a direct Wi-Fi connection.

In an embodiment, device (110), device (120), and device (130) generally represent any device that includes a hardware processor. Examples of devices in accordance with one or more embodiments include, but are not limited to, a desktop, a laptop, a tablet, a phablet, a cellular phone, a smart phone, a Personal Digital Assistant (PDA), a kiosk, and a server.

In an embodiment, the data storage of any device (e.g., device (110), device (120), and device (130)) includes a fast read-write memory for storing programs and data during the execution of an operating system and a hierarchy of persistent memory such as ROM, EPROM, and Flash memory for storing instructions and data needed for the startup and/or operations of device (110). In an embodiment, the I/O interface of device (110) corresponds to one or more components used for communicating with other devices via wired or wireless segments. The I/O interface may include a wired network interface such as an IEEE 802.3 Ethernet interface and/or a wireless interface such as an IEEE 802.11 Wi-Fi® interface.

In an embodiment, a processor is coupled to the data storage and the I/O interface. The processor may be any processing device including, but not limited to a MIPS-class processor, a microprocessor, a digital signal processor, an application specific integrated circuit, a microcontroller, a state machine, or any type of programmable logic array.

In an embodiment, device (110) is a watch phone that is communicatively coupled with device (120) and/or device (130). In one example, device (110) and device (120) are configured to perform synchronization operations for a set of data. The synchronization operations include transmitting data from device (110) to device (120) and/or transmitting data from device (120) to device (110). A synchronization operation is performed to synchronize a single data set, a portion of the single data set, multiple data sets, and/or all data stored on two or more devices.

In an embodiment, a synchronization operation involves partitioning a data set into multiple subsets of data and performing a separate synchronization operation for each subset of data. Various synchronization operations, corresponding to each subset of data, may be performed concurrently, consecutively, or with intervening time intervals.

In an example, a synchronization operation is performed over a direct connection (for example, NFC or Bluetooth). In another example, a synchronization operation is performed over a network connection (for example, Local Area Network, Wide Area Network, and/or Cellular Network).

3. Performing a Synchronization Operation

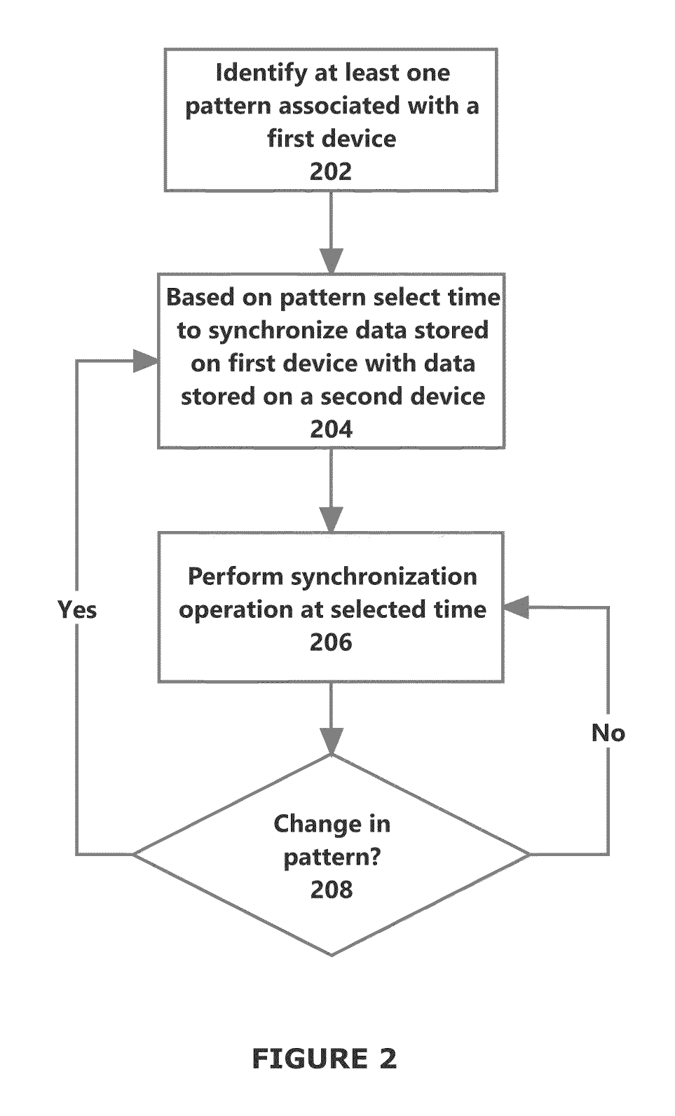

FIG. 2 illustrates an example set of operations for performing a synchronization operation. Operations for performing a synchronization operation, as described herein with reference to FIG. 2, may be omitted, rearranged, or modified. Furthermore, operations may be added or performed by different components or devices. Accordingly, the specific set or sequence of operations should not be construed as limiting the scope of any of the embodiments.

3.1 Identifying At Least One Pattern

In an embodiment, at least one pattern associated with a first device is identified (Operation 202). Identifying the at least one pattern associated with the first device may be performed by the first device itself and/or by other devices.

In an embodiment, the at least one pattern includes identifying historical patterns associated with a state of one or more device components. In one example, a battery level of the first device may be recorded every five minutes. The recording includes a percentage of remaining battery power or a general power category (e.g., low, medium, and high). A pattern of time periods in a day, in a week day, or in a weekend day with corresponding battery levels is identified. The pattern indicates that a user's laptop has a high battery level every morning, low battery level early afternoon, and high battery level in the evening.

In another example, the at least one pattern includes a battery charging pattern. The battery charging pattern indicates that a cell phone is charged from noon to 1 pm on most days (e.g., when a user is at lunch) and from 10 pm to 6 am, Sunday through Thursday nights (e.g., when the user is asleep).

In another example, the at least one pattern includes a resource utilization pattern. The pattern indicates that a user's tablet is used heavily from each weekday from 9 am to noon and from 2 pm to 5 pm. A heavy usage pattern is identified based on CPU utilization percentage, an amount of data downloaded from a network, an amount of data uploaded to a network, a percentage of Random Access Memory (RAM) being used, and/or any other characteristic associated with the device. Alternatively, the pattern may specifically relate to the characteristics of one or more device components. For example, a CPU utilization pattern may be identified that indicates typical periods in a day of heavy CPU utilization above a particular threshold and low CPU utilization below the particular threshold. In another example, a pattern identifies network I/O patterns or disk I/O patterns. The pattern identifies typical time periods when the desktop computer system uses very little of the available bandwidth for downloading data from a network and/or uploading data to a network.

In an embodiment, identifying a pattern includes identifying a data usage pattern. The pattern indicates access patterns for various data sets. For example, a pattern may indicate that data stored in the “Economics 101” folder on a university student's laptop is used (a) every Monday, Wednesday, and Friday from 11 am to noon (e.g., when the student has the “Economics 101” class) and (b) every Sunday, Tuesday, Thursday from 7 pm to 8 pm (e.g., when the student completes the homework).

In an embodiment, identifying a pattern includes classifying data sets stored on the first device into different priority levels. In an example, a first data set is identified as high priority because emails associated with the first data set are identified as high priority emails. A second data set is identified as low priority because emails associated with the second data set are not classified as high priority. A particular data set is associated with an incoming email when content from the incoming email is downloaded into that particular data set. A particular data set is associated with an outgoing email when content in the outgoing email is uploaded from that particular data set.

In an embodiment, identifying a pattern associated with the first device includes identifying a connectivity pattern for the first device. In an example, a pattern identifies time periods when a cellular phone is usually connected to a Wi-Fi network (e.g., in the evenings between 6 pm and 8 pm). In another example, a pattern identifies time periods when the cellular phone is in a “data roaming” state resulting in higher charges to a user for any data uploaded or downloaded by the cellular phone.

In an embodiment, identifying a pattern associated with the first device includes an application usage pattern. For example, a pattern identifies time periods when a desktop computer system is typically streaming YouTube® videos (YouTube® is a registered trademark of Google, Inc.). In another example, a pattern indicates time periods when the desktop computer system is being used for gaming.

In an embodiment, a pattern indicates typical usage time periods of data to be synchronized. In an example, access to a data set that is periodically synchronized is tracked. The time periods during which the data set is accessed is aggregated to determine an access pattern for the data set.

In an embodiment, patterns may be determined based on a subset of data points. For example, a determination is made that a user's cellular phone was charged 330 nights in a year from approximately 11 pm to 6 am. The cellular phone was not charged during the remaining 35 nights of the year. The charging pattern of 11 pm to 6 am is identified while ignoring the outliers (i.e., the 35 nights during which the cellular phone was not charged from 11 pm to 6 am). In another example, patterns may be determined based on averages, modes, and/or any other statistical calculations.

3.2 Selecting a Time for a Synchornization Operation Based on the At Least One Pattern

In an embodiment, a time is selected for performing a synchronization operation based on the at least one pattern associated with the first device (Operation 204). The synchronization operation, further described below in relation to Operation 206, synchronizes at least a portion of the data stored on the first device with at least a portion of data stored on a second device. The time is selected by the first device itself and/or by other devices. Selection of the time may include selecting an exact time, or selecting a time window.

In an embodiment, selecting a time for performing a synchronization operation includes determining a typical period of time during which the first device has a battery level above a threshold value. In an example, 10 am daily is selected as a time for performing a synchronization operation based on a pattern which identifies 10 am daily as a time when the first device has a battery level above ninety percent. The historical pattern representing battery levels in the past may be combined with current readings. In the example, the current battery level is detected at 10 am daily, i.e., the time selected based on the historical pattern. Thereafter, if the current battery level is over 70%, then a synchronization operation is immediately executed.

In an embodiment, selecting a time for performing a synchronization operation includes determining a typical period of time during which the first device is charged. In an example, 12:30 pm is selected for performing a synchronization operation based on a pattern indicating that the cell phone is usually charged from noon to 1 pm on most days.

In an embodiment, selecting a time for performing a synchronization operation includes selecting a period of time during which the first device is typically not used (or not heavily used). In an example, Sam is selected for performing a synchronization operation for a tablet based on a pattern indicating that the tablet is heavily used from 9 am to noon and 2 pm to 5 pm (i.e., not at 8 am). In another example, Sam is selected based on a pattern indicating that the tablet is not heavily used from 5 pm to 9 am the following day.

In an embodiment, selecting a time for performing a synchronization operation includes selecting a time based on expected use of the data to be synchronized. In an example, a time of 10 am on a Wednesday is selected for synchronizing data on a student's laptop that is associated with an “Economics 101” folder based on a pattern indicating that data in the “Economics 101” folder is typically accessed one hour later, at 11 am on Wednesdays.

In an example, the expected use of the data refers to expected use by other devices. In an example, a student's data is uploaded to a server via synchronization operation based on a pattern indicating that other team members are likely going to download the data soon.

In an embodiment, selecting a time for performing a synchronization operation includes selecting a time based on a priority of the data to be synchronized. In an example, a high priority data set is synchronized multiple times in single day while a low priority data set is synchronized only once a day. In another example, data sets are ordered for synchronization operations. Specifically, a high priority data set is synchronized before a low priority data set is synchronized when resources for synchronization are available, or when a synchronization criteria is met for initiating synchronization operations.

In an embodiment, selecting a time for performing a synchronization operation includes selecting a time during which the device is known to have a good level of connectivity with a network. For example, based on a pattern indicating intermittent Wi-Fi connectivity from 11 am to 1 pm daily and strong Wi-Fi connectivity from 1 pm to 3 pm daily, the synchronization operation is scheduled between 1 pm and 3 pm daily. Accordingly, even when a user's device is connected to Wi-Fi from 11 am to 1 pm, the synchronization operation is not initiated because of (a) the known poor connectivity pattern from 11 am to 1 pm and/or (b) the pattern of a better connectivity period from 1 pm to 3 pm.

In an embodiment, selecting a time for performing a synchronization operation includes selecting a time when a cost to a user is minimal. For example, a time when a user is typically in a home cellular network is selected, and times when a user is typically in a different “roaming” network are avoided. In another example, a time when a device is historically connected to a Wi-Fi connection is selected and times when the device typically does not have a Wi-Fi connection are avoided.

In an example, a device is to be synchronized daily. A detected pattern indicates that the device typically does not connect to any Wi-Fi network on Tuesdays. In addition, the detected pattern indicates that the device does connect to a Wi-Fi network on Wednesday in the afternoon. Based on the pattern, synchronization operations are performed on Tuesdays in the morning over the cellular network because there is no better option on Tuesdays than the cellular network. In contrast, the cellular connection is not used for performing synchronization operations on Wednesdays because the pattern indicates that the device typically connects to a Wi-Fi network on Wednesday afternoons. The synchronization operation on Wednesdays is performed during the afternoons via the Wi-Fi connection to save the user data charges for data transmission over the cellular network.

In an embodiment, selecting a time for performing a synchronization operation includes avoiding time periods when other applications associated with heavy bandwidth usage are typically executing. In an example, a time is selected which does not coincide with time periods when a device is typically used for online gaming or for streaming videos as indicated by a usage pattern.

In an embodiment, selecting a time for performing a synchronization operation includes selecting candidate times based on a historical pattern. At each of the candidate times, current characteristics of the first device, second device, or a network are evaluated. If the current characteristics meet a synchronization criteria, then the synchronization operation is performed at the candidate time. If the current characteristics do not meet a synchronization criteria, then the synchronization is not performed, and the characteristics are re-evaluated at the next candidate time. In addition, a maximum synchronization interval between synchronization operations may be implemented to force synchronization even when the current characteristics do not meet the synchronization criteria.

In one example, 11 am, 3 pm, and 10 pm are selected as candidate times for performing a synchronization operation based on the at least one pattern associated with the first device. At 11 am, a CPU utilization of 80% is detected which is above a maximum value of 50% defined in a synchronization criteria. As a result, the synchronization operation is not performed at 11 am. At the next candidate time of 3 pm, a CPU utilization of 40% is detected which is below the maximum value of 50% defined in the synchronization criteria. As a result, the synchronization operation is performed at 3 pm as further described below in relation to Operation 206.

3.3 Performing a Synchronization Operation

In an embodiment, a synchronization operation is performed at the selected time (Operation 206). Performing a synchronization operation includes transmitting and/or receiving data by the first device. For example, data stored on a server related to an “English 101” class may be transmitted to a student's laptop at a selected time of 6 pm prior to the student's typical study time of 7 pm.

In another example, user input, entered by a student into a locally stored document, is determined to be of high priority because the user input includes responses to an examination. The synchronization operations are performed for high priority data every one minute. Accordingly, a copy of the locally stored document is transmitted to a server every minute. The transmission results in synchronization of the document between the student's device and a web server.

In an embodiment, performing a synchronization operation includes requesting a user to authorize synchronization at a time that is selected based on a pattern. In an example, a pop up message is displayed on a watch phone at a time selected for synchronization based on a usage pattern for a cellular phone. The pop up message requests a user to authorize a synchronization operation for the user's contacts stored on the user's cellular phone. Once a user submits an approval, the user's contacts from the user's cellular phone are synchronized with a server.

In an embodiment, a pattern determined for a device may be updated (Operation 208). In an example, a student's “Economics 101” class is completed at the end of a semester. As a result, the student stops attending the “Economics 101” class from 10 am to 11 am on Monday, Wednesday, and Friday and stops accessing the data in the “Economics 101” folder. The system determines that the data is no longer being accessed on a regular basis. Based on the determination that the data is no longer being accessed, automatic synchronization operations related to the “Economics 101” class are stopped.

In another example, a first pattern is determined indicating that a student's tablet typically has good Wi-Fi connectivity from 11:30 am to 12:30 pm (e.g., when the student is in a cafeteria eating lunch). Based on the Wi-Fi connectivity pattern, a network device schedules the student's tablet for synchronization operations at noon. However, once the semester finishes, the student's schedule changes to having lunch from 12:30 pm to 1:30 pm. The network device determines that a typical good connectivity time period has switched from 11:30 am-12:30 pm to 12:30 pm-1:30 pm. As a result, the network device updates the time for performing synchronization operations for the tablet from noon to 1 pm.

4. Synchronization Operations Based on a Current Battery Level

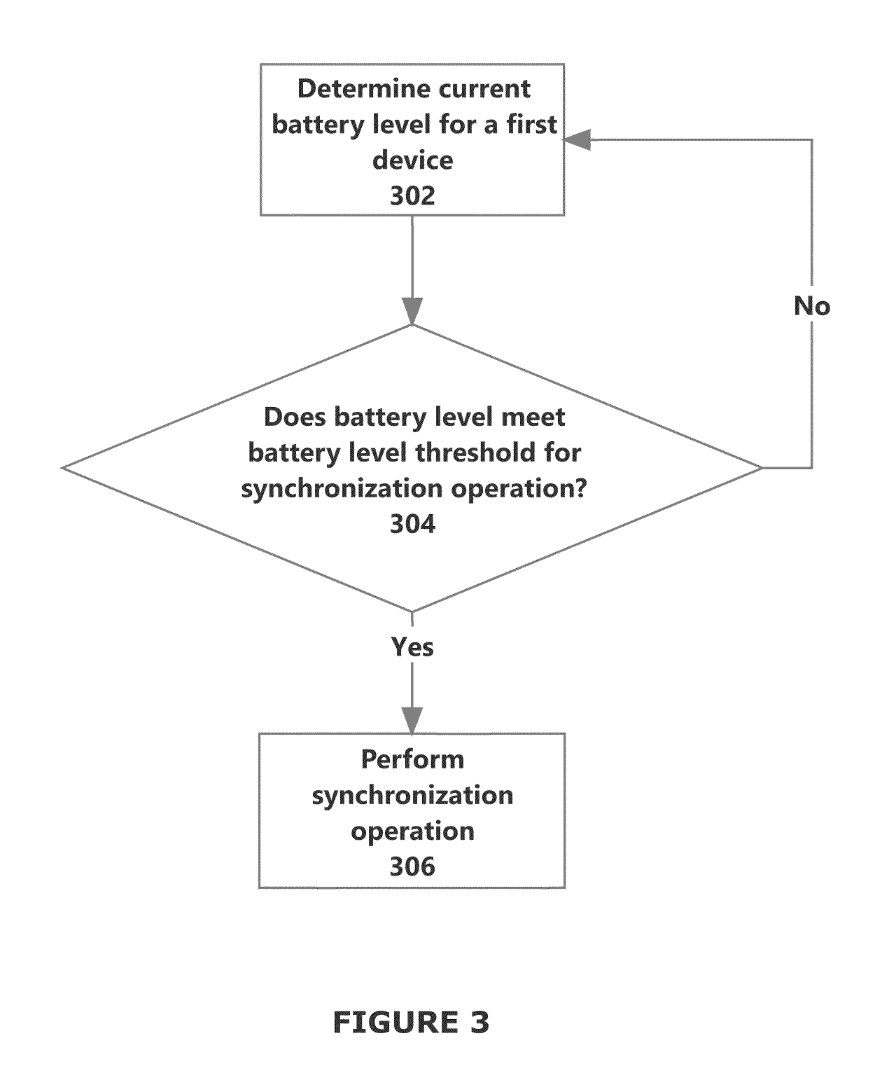

FIG. 3 illustrates an example set of operations for performing a synchronization operation. Operations for performing a synchronization operation, as described herein with reference to FIG. 3, may be omitted, rearranged, or modified. Furthermore, operations may be added or performed by different components or devices. Accordingly, the specific set or sequence of operations should not be construed as limiting the scope of any of the embodiments. One or more operations as described above in relation to FIG. 2 may be combined with one or more operations as described below in relation to FIG. 3.

In an embodiment, a current battery level is determined for a first device (Operation 302). The battery level is determined by an application executing on the first device or determined by an application executing on a different device. In an example, determining a current battery level includes determining a percentage of the charge remaining on a battery. In another example, determining a current battery level includes determining whether a level of charge remaining on a battery falls into a low, medium, or high category.

In an embodiment, the current battery level is compared to a battery level threshold associated with a synchronization operation to determine whether the current battery level meets the battery level threshold (Operation 304). Operation 304 may be periodically, continuously, or at times selected based on patterns as described in Operation 204.

In an embodiment, different synchronization operations correspond to synchronization of different sets of data. Each synchronization operation may be associated with a respective battery level threshold such that the synchronization operation is only performed when a current battery level meets the respective battery level threshold (Operation 306). In an example, low priority data is only synchronized when a current battery level is “high” or when a current battery level is above 80%. In contrast, high priority data is synchronized when a current battery level is “high” or “medium”, or when the current battery level is above 35%.

5. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

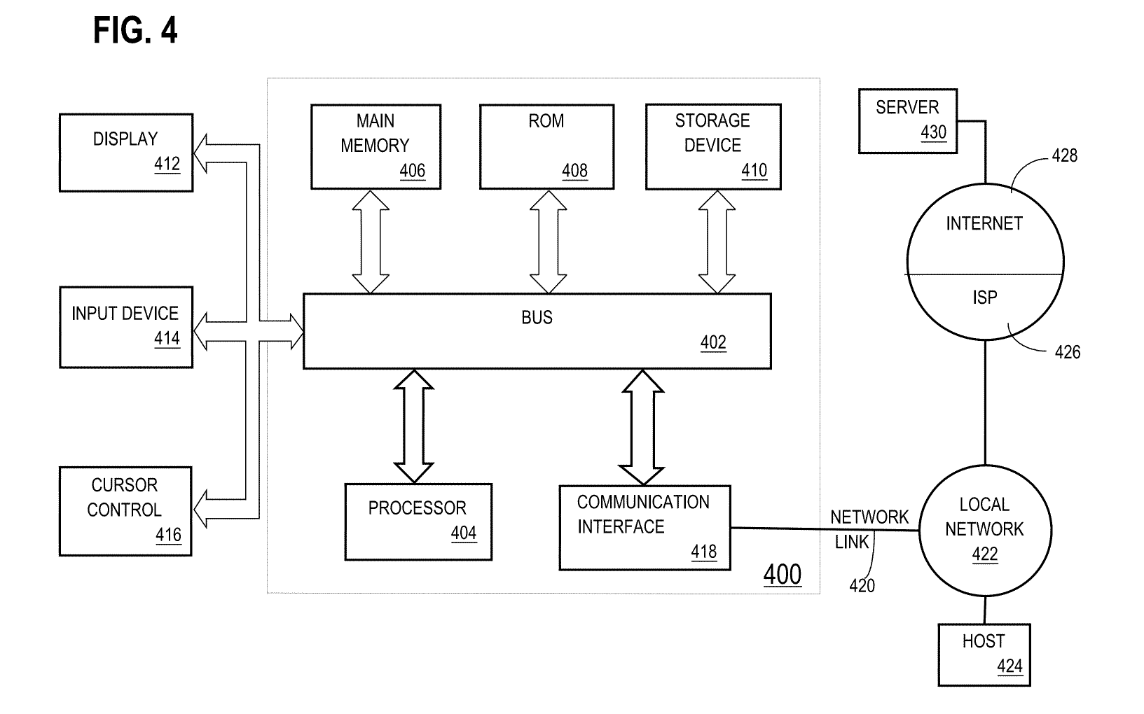

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 440, such as a magnetic disk or optical disk, is provided and coupled to bus 402 for storing information and instructions.

Computer system 400 may be coupled via bus 402 to a display 442, such as a cathode ray tube (CRT), for displaying information to a computer user. An input device 444, including alphanumeric and other keys, is coupled to bus 402 for communicating information and command selections to processor 404. Another type of user input device is cursor control 446, such as a mouse, a trackball, or cursor direction keys for communicating direction information and command selections to processor 404 and for controlling cursor movement on display 442. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 440. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 440. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 440 either before or after execution by processor 404.

Computer system 400 also includes a communication interface 448 coupled to bus 402. Communication interface 448 provides a two-way data communication coupling to a network link 420 that is connected to a local network 422. For example, communication interface 448 may be an integrated services digital network (ISDN) card, cable modem, satellite modem, or a modem to provide a data communication connection to a corresponding type of telephone line. As another example, communication interface 448 may be a local area network (LAN) card to provide a data communication connection to a compatible LAN. Wireless links may also be implemented. In any such implementation, communication interface 448 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 448, which carry the digital data to and from computer system 400, are example forms of transmission media.

Computer system 400 can send messages and receive data, including program code, through the network(s), network link 420 and communication interface 448. In the Internet example, a server 430 might transmit a requested code for an application program through Internet 428, ISP 426, local network 422 and communication interface 448.

The received code may be executed by processor 404 as it is received, and/or stored in storage device 440, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A non-transitory computer readable medium comprising instructions which, when executed by one or more hardware processors, causes performance of operations comprising:
monitoring a first device to identify at least one pattern associated with the first device;
based on the at least one pattern, selecting a time to synchronize a first data stored on the first device with a second data stored on a second device;
synchronizing the first data stored on the first device with the second data stored on the second device at the selected time.

2. The medium of claim 1, wherein the at least one pattern represents historical battery levels at various times during a day.

3. The medium of claim 1, wherein the at least one pattern represents historical battery charging patterns at various times during a day.

4. The medium of claim 1, wherein the operations further comprise modifying the selected time based on a change detected in the at least one pattern.

5. The medium of claim 1, wherein the at least one pattern is a connectivity pattern.

6. The medium of claim 5, wherein the connectivity pattern comprises one or more of:
a Wi-Fi connectivity pattern representing historical time periods during which the first device had a Wi-Fi connection;
a mobile network connectivity representing historical time periods during which the first device had a mobile network connection.

7. The medium of claim 1, wherein the at least one pattern comprises a resource utilization pattern.

8. The medium of claim 1, wherein the at least one pattern comprises applications currently executing.

9. The medium of claim 1, wherein selecting the time based further on time periods identified by the second device or a third device.

10. The medium of claim 1, wherein the at least one pattern predicts a particular time of use of the first data, and wherein selecting the time comprises selecting a time prior to the particular time.

11. The medium of claim 1, wherein the at least one pattern predicts a first time period when synchronization of the first data is (a) not possible or (b) not optimal, and wherein selecting the time to synchronize the first data comprises selecting a second time period that is prior to the first time period.

12. The medium of claim 1, wherein the operations further comprise:
determining a set of resources necessary for synchronizing the first data stored on the first device with the second data stored on the second device;
based on the necessary set of resources, selecting a particular connection type from a set of available connection types for performing the synchronizing operation.

13. The medium of claim 1, wherein the operations further comprise:
determining a set of resources necessary for synchronizing the first data stored on the first device with the second data stored on the second device;
based on the necessary set of resources, selecting one or more components of the first device from a set of available components for performing the synchronizing operation.

14. The medium of claim 1, wherein selecting the time is responsive to determining that the time is associated with a low user activity period based on the at least one pattern.

15. The medium of claim 1, wherein synchronizing operation comprises:
ordering subsets of the first data for synchronization based on priority corresponding to each subset of the subsets.

16. The medium of claim 1, wherein the at least one pattern associated with the first device is based on historical data.

17. The medium of claim 1, wherein the at least one pattern associated with the first device indicates a monetary cost associated performing synchronization operations at various time periods.

18. The medium of claim 1, wherein the at least one pattern associated with the first device estimates a time necessary for performing synchronization operations at various time periods based on differences in connection speed or bandwidth at the various time periods.

19. A non-transitory computer readable medium comprising instructions which, when executed by one or more hardware processors, causes performance of operations comprising:
obtaining a first threshold battery level associated with a first synchronization operation;
determining whether a current battery level for the first device meets the first threshold battery level associated with the first synchronization operation;
responsive to determining that the current battery level for the first device meets the first threshold battery level associated the first synchronization operation, performing the first synchronization operation;
responsive to determining that the current battery level for the first device does not meet the first threshold battery level associated with the first synchronization operation, refraining from performing the first synchronization operation.

20. The medium of claim 19, wherein the operations further comprise:
obtaining a second threshold battery level associated with a second synchronization operation;
determining whether the current battery level for the first device meets the second threshold battery level associated with the second synchronization operation;
responsive to determining that the current battery level for the first device meets the second threshold battery level associated the second synchronization operation, performing the second synchronization operation;
responsive to determining that the current battery level for the first device does not meet the second threshold battery level associated with the second synchronization operation, refraining from performing the second synchronization operation;
wherein the first threshold battery level associated with the first synchronization operation is different than the second threshold battery level associated with the second synchronization operation.
